(19) United States
(12) Patent Application Publication
(10) Pub. No.: US 2020/0131801 A1
(43) Pub. Date: Apr. 30, 2020

(54) Latch Guiding And Coupling Device

(71) Applicant: I-TEK METAL MFG. CO., LTD, Tainan (TW)

(72) Inventor: Hung-Jen Tien, Tainan (TW)

(21) Appl. No.: 16/211,478

(22) Filed: Dec. 6, 2018

(30) Foreign Application Priority Data
Oct. 31, 2018 (TW) 107214796

(51) Int. Cl. E05B 15/02

(52) U.S. Cl. CPC E05B 15/0205; E05Y 2900/132

(57) ABSTRACT

A latch guiding and coupling device includes a coupling seat having first and second sides. An insertion groove is defined between the first and second sides and extends from a first surface through a second surface of the coupling seat. A recessed portion is formed in the first side and rotatably receives a roller. Each of two ends of the recessed portion has a positioning groove extending to the first surface to form a notch. An axle extends through the roller and includes two ends respectively received in the positioning grooves. A locking plate is mounted to the first surface of the coupling seat. The locking plate includes an opening aligned with the insertion groove and two stopper portions aligned with the positioning grooves. Each stopper portion covers one of the notches to prevent the axle from disengaging from the positioning grooves. The roller protrudes beyond the locking plate.

### BACKGROUND OF THE INVENTION

The present invention relates to a latch guiding and coupling device and, more particularly, to a latch guiding and coupling device that is mounted to a side of a door frame and that can be easily assembled and maintained.

A typical door lock device generally includes a latch guiding and coupling device mounted to a side of a door frame and a latching unit mounted to a door. The latch guiding and coupling device includes a coupling seat and a locking plate extending from the coupling seat. A guiding plate extends from a side of the locking plate. An insertion groove is recessed in the coupling seat. When the latching unit on the door is misaligned from the latch guiding and coupling device, the door is in an open state. On the other hand, when the latching unit on the door is aligned with the latch guiding and coupling device, the door is aligned with the door frame and is in a closed state. During closing of the door, a latch of the latching unit impacts the guiding plate and then enters the insertion groove. After long-term use, the latch is liable to deviate, and the movement of the latch between the latching and unlatching positions is not smooth, such that the latch is difficult to or even cannot enter the insertion groove. As a result, the door cannot be closed.

In an approach to solve the above disadvantage, a roller is mounted in the latch guiding and coupling device. When the door is moving to the closed position, the latch comes in contact with and rotates the roller, guiding the latch into the insertion groove. However, an axle of the roller extends through the coupling seat and the roller and has two ends fixed in the coupling seat, leading to difficulties in assembly and maintenance. In some cases, the roller cannot be detached, such that the whole latch guiding and coupling device must be replaced.

### BRIEF SUMMARY OF THE INVENTION

The present invention provides a latch guiding and coupling device including a coupling seat having a first side and a second side. An insertion groove is defined between the first side and the second side. The coupling seat further includes a first surface and a second surface. The insertion groove extends from the first surface through the second surface. A recessed portion is formed in the first side and includes two ends. Each of the two ends of the recessed portion has a positioning groove. Each positioning groove extends to the first surface to form a notch. A roller includes an axle extending along a longitudinal axis of the roller. The axle includes two ends respectively received in the positioning grooves of the coupling seat. The roller is rotatably received in the recessed portion of the coupling seat. A locking plate is mounted to the first surface of the coupling seat. The locking plate includes an opening aligned with the insertion groove. The locking plate further includes two stopper portions aligned with the positioning grooves of the coupling seat. Each of the two stopper portions covers one of the notches of the positioning grooves to prevent the axle from disengaging from the positioning grooves. The roller protrudes beyond the locking plate.

Since the first side of the coupling seat includes the recessed portion having two ends with positioning grooves extending to the first surface to form notches, the two ends of the axle can easily be inserted into the positioning grooves via the notches. Furthermore, the stopper portions of the locking plate cover the notches, such that the roller can be easily and pivotably mounted in the recessed portion of the coupling seat, achieving assembly of the latch guiding and coupling device. For maintenance operation of the latch guiding and coupling device, the roller can be easily maintained or replaced after removal of the locking plate. Thus, the latch guiding and coupling device according to the present invention can be easily assembled and maintained.

In an example, the coupling seat includes a plurality of fixing holes, the locking plate includes a plurality of positioning holes, and wherein a plurality of fasteners extends through the plurality of positioning holes and is removably fixed in the plurality of fixing holes of the coupling seat.

In an example, the locking plate further includes a guiding plate extending laterally therefrom. The guiding plate includes an arcuate side extending from a distal end of the guiding plate towards the coupling seat.

The present invention will become clearer in light of the following detailed description of illustrative embodiments of this invention described in connection with the drawings.

### DESCRIPTION OF THE DRAWINGS

FIG. 1 is an exploded, perspective view of a latch guiding and coupling device of an embodiment according to the present invention.

FIG. 2 is a perspective view of the latch guiding and coupling device of FIG. 1.

FIG. 3 is a schematic cross sectional view of the latch guiding and coupling device of FIG. 1 mounted in a door frame and a latch mounted to a door, illustrating movement of the latch guided by a roller.

FIG. 4 is a view similar to FIG. 3 with the latch guided by the roller into an insertion groove of a coupling seat.

FIG. 5 is a cross sectional view taken along section line 5-5 of FIG. 4.

FIG. 6 is a cross sectional view taken along section line 6-6 of FIG. 4.

All figures are drawn for ease of explanation of the basic teachings of the present invention only; the extensions of the figures with respect to number, position, relationship, and dimensions of the parts to form the embodiments will be explained or will be within the skill of the art after the following teachings of the present invention have been read and understood. Further, the exact dimensions and dimensional proportions to conform to specific force, weight, strength, and similar requirements will likewise be within the skill of the art after the following teachings of the present invention have been read and understood.

Where used in the various figures of the drawings, the same numerals designate the same or similar parts. Furthermore, when the terms “first”, “second”, “side”, “end”, “portion”, “longitudinal”, “lateral”, and similar terms are used herein, it should be understood that these terms have reference only to the structure shown in the drawings as it would appear to a person viewing the drawings and are utilized only to facilitate describing the invention.

### DETAILED DESCRIPTION OF THE INVENTION

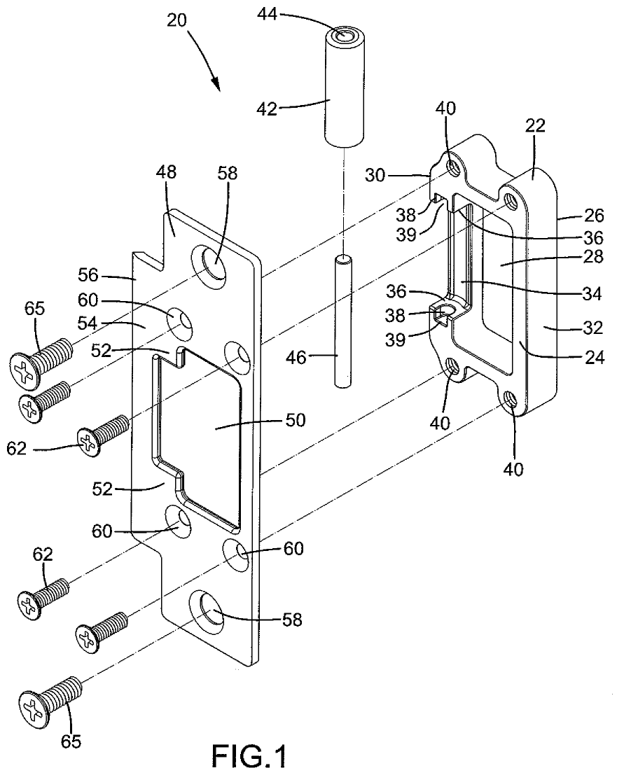

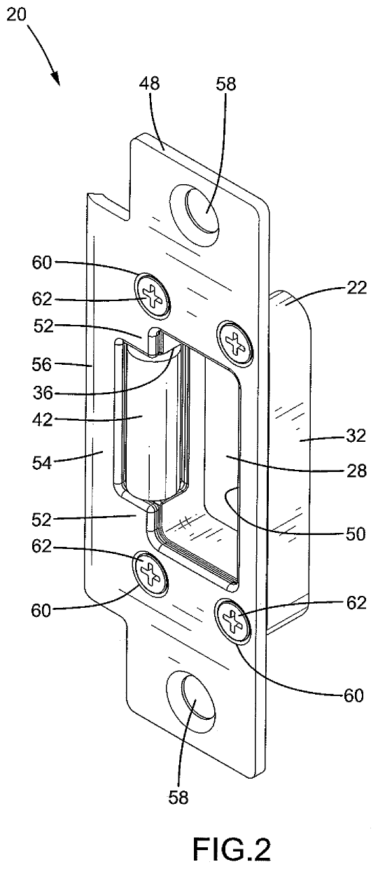

With reference to FIGS. 1 and 2, a latch guiding and coupling device 20 according to the present invention includes a coupling seat 22 having a first surface 24 and a second surface 26 spaced from the first surface 24. The coupling seat 20 further includes first and second sides 30 and 32 between the first surface 24 and the second surface 26. An insertion groove 28 is defined between the first side 30 and the second side 32. The insertion groove 28 extends from the first surface 24 through the second surface 26. A recessed portion 34 is formed in the first side 30 and includes two ends. Each of the two ends of the recessed portion 34 includes a lateral wall 36 having a positioning groove 38. Each positioning groove 38 extends to the first surface 24 to form a notch 39. A plurality of fixing holes 40 is defined in the first surface 24 of the coupling seat 22. Each of the plurality of fixing holes 40 can be a thread-free bore or has an inner threading.

With reference to FIGS. 1 and 2, the latch guiding and coupling device 20 further includes a roller 42 having an axle 46 extending along a longitudinal axis of the roller 42. Specifically, the roller 42 includes a longitudinal hole 44, and the axle 46 extends through the longitudinal hole 44 and has two ends extending beyond the roller 42. The two ends of the axle 46 are respectively received in the positioning grooves 38 of the recessed portions 34 of the coupling seat 22. The roller 42 is rotatably received in the recessed portion 34 of the coupling seat 22. An outer periphery of the roller 42 partially protrudes beyond the first surface 24 of the coupling seat 22.

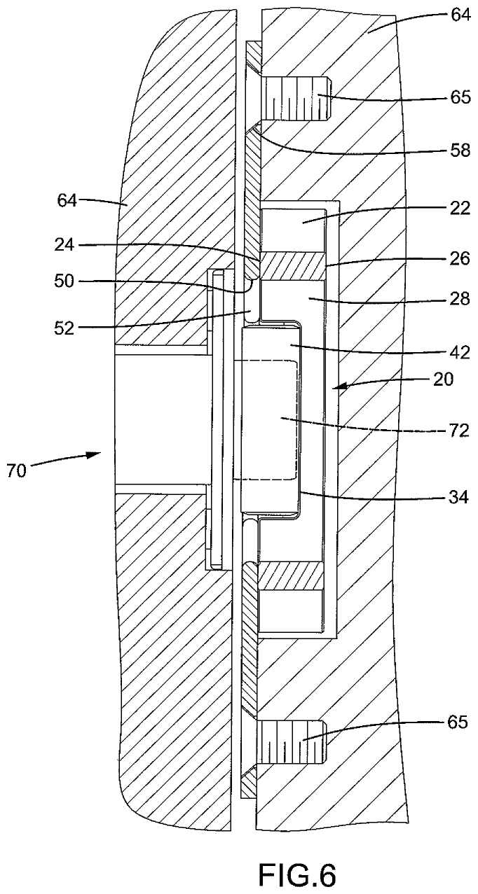

With reference to FIGS. 1 and 2, the latch guiding and coupling device 20 further includes a locking plate 48 mounted to the first surface 24 of the coupling seat 22. The locking plate 48 includes an opening 50 and two stopper portions 52 formed on a peripheral wall of the opening 50. The opening 50 is aligned with the insertion groove 28 and the recessed portion 34. The two stopper portions 52 are aligned with the notches 39 of the positioning grooves 38 extending to the first surface 24 of the coupling seat 22. The locking plate 48 further includes a guiding plate 54 extending laterally therefrom. An arcuate side 56 extends from a distal end of the guiding plate 54 towards the coupling seat 22. The locking plate 48 includes a plurality of through-holes 58 and a plurality of positioning holes 60. A plurality of screws 65 extends through the plurality of through-holes 58 into a door frame 64 (see FIG. 6). The plurality of positioning holes 60 is aligned with the plurality of fixing holes 40. The locking plate 48 is mounted to the coupling seat 22. Specifically, the locking plate 48 abuts against the first surface 24 of the coupling seat 22, and a plurality of fasteners 62 extends through the plurality of positioning holes 60 of the locking plate 48 and the plurality of fixing holes 40 of the coupling seat 22. The plurality of fasteners 62 can be screws extending through the plurality of positioning holes 60 of the locking plate 48 and can threadedly engage with the inner threadings of the plurality of fixing holes 40 of the coupling seat 22, thereby securely fixing the locking plate 40 to the first surface 24 of the coupling seat 22.

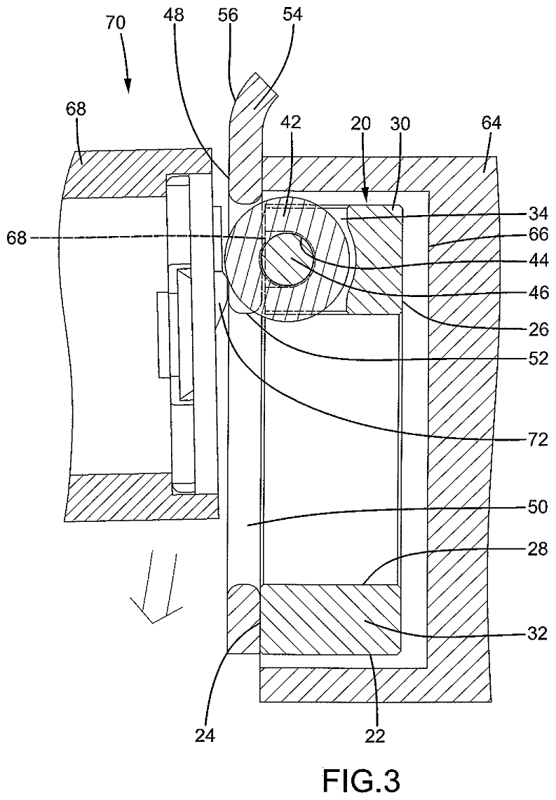

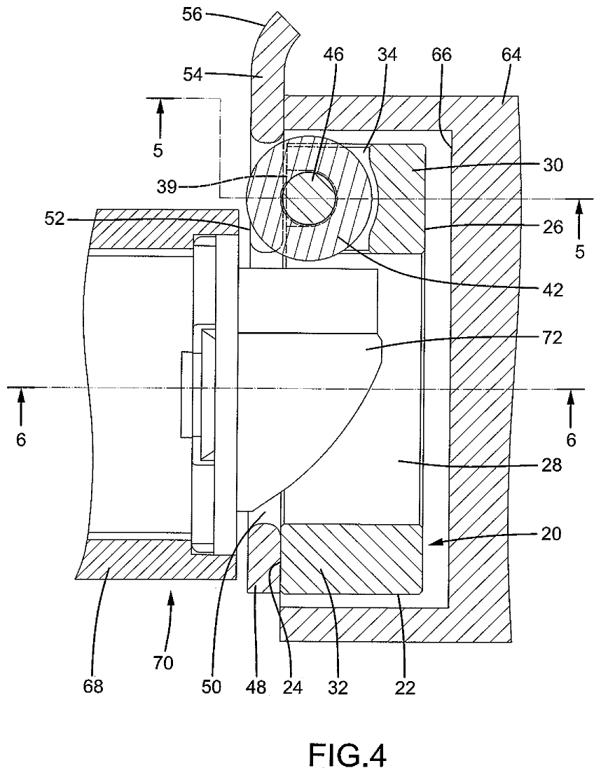

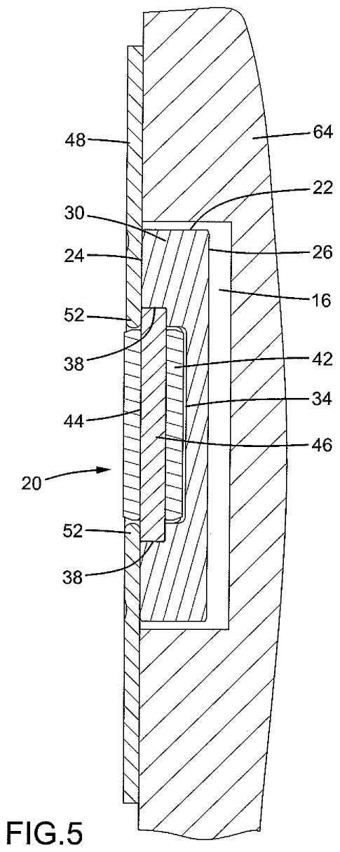

With reference to FIGS. 3-6, the latch guiding and coupling device 20 is mounted in a fixing groove 66 in a side of the door frame 64, and a rear side of the locking plate 48 abuts a wall of the fixing groove 66 (see FIG. 3). A latching unit 70 is disposed on a door 68 pivotably mounted to another side of the door frame 64. The latching unit 70 includes a latch 72. When the latching unit 70 on the door 68 is not aligned with the latch guiding and coupling device 20, the door 68 is in an open state. When it is desired to close the door 68, the door 68 is pivoted. During the closure of the door 68, the latch 72 firstly comes into contact with the guiding plate 54 and, thus, retracts. Then, the latch 72 is guided by the guiding plate 54 to press against the outer periphery of the roller 42 and, thus, further retracts. At the same time, the latch 72 rotates the roller 42. After the latch 72 moves across the roller 42, the latch 72 returns to its original, extended position and extends into the insertion groove 28 of the coupling seat 22. At this time, the latching unit 70 on the door 68 is aligned with the latch guiding and coupling device 20, and the door 68 is aligned with the door frame 64 and is therefore in the closed state (see. FIG. 4).

Since the first side 30 of the coupling seat 22 includes the recessed portion 34 having two ends with positioning grooves 38 extending to the first surface 24 to form notches 39, the two ends of the axle 46 can easily be inserted into the positioning grooves 38 via the notches 39. Furthermore, the stopper portions 52 of the locking plate 48 cover the notches 39, such that the roller 42 can be easily and pivotably mounted in the recessed portion 34 of the coupling seat 22, achieving assembly of the latch guiding and coupling device 20. For maintenance operation of the latch guiding and coupling device 20, the roller 42 can be easily maintained or replaced after removal of the locking plate 48. Thus, the latch guiding and coupling device 20 according to the present invention can be easily assembled and maintained.

Now that the basic teachings of the present invention have been explained, many extensions and variations will be obvious to one having ordinary skill in the art. For example, the insertion groove 28 can extend from the first surface 24 towards and but be spaced from the second surface 26 without adversely affecting insertion of the latch 72 into the insertion groove 28 when the latching unit 70 is aligned with the latch guiding and coupling device 20. Thus, the door 68 can be reliably aligned with the door frame 64 when in a closed state.

Thus since the invention disclosed herein may be embodied in other specific forms without departing from the spirit or general characteristics thereof, some of which forms have been indicated, the embodiments described herein are to be considered in all respects illustrative and not restrictive. The scope of the invention is to be indicated by the appended claims, rather than by the foregoing description, and all changes which come within the meaning and range of equivalency of the claims are intended to be embraced therein.

1. A latch guiding and coupling device comprising:
a coupling seat including a first side and a second side, wherein an insertion groove is defined between the first side and the second side, wherein the coupling seat further includes a first surface and a second surface, wherein the insertion groove extends from the first surface through the second surface, wherein a recessed portion is formed in the first side and includes two ends, wherein each of the two ends of the recessed portion has a positioning groove, wherein each positioning groove extends to the first surface to form a notch;
a roller including an axle extending along a longitudinal axis of the roller, wherein the axle includes two ends respectively received in the positioning grooves of the coupling seat, wherein the roller is rotatably received in the recessed portion of the coupling seat; and
a locking plate mounted to the first surface of the coupling seat, wherein the locking plate includes an opening aligned with the insertion groove, wherein the locking plate further includes two stopper portions aligned with the positioning grooves of the coupling seat, wherein each of the two stopper portions covers one of the notches of the positioning grooves to prevent the axle from disengaging from the positioning grooves, and wherein the roller protrudes beyond the locking plate.

2. The latch guiding and coupling device as claimed in claim 1, further comprising a plurality of fasteners, wherein the coupling seat includes a plurality of fixing holes, wherein the locking plate includes a plurality of positioning holes, and wherein the plurality of fasteners extends through the plurality of positioning holes and is removably fixed in the plurality of fixing holes of the coupling seat.

3. The latch guiding and coupling device as claimed in claim 1, wherein the locking plate further includes a guiding plate extending laterally therefrom, wherein the guiding plate includes an arcuate side extending from a distal end of the guiding plate towards the coupling seat.
